(19) United States
(12) Patent Application Publication
(10) Pub. No.: US 2005/0144109 A1
(43) Pub. Date: Jun. 30, 2005

(54) Electronic trading data integration and protection system

(76) Inventors: Michael Boni, Marietta, GA (US); Greg Hamamgian, Woodstock, GA (US); Edwin Marcial, Smyrna, GA (US); Jeffrey C. Sprecher, Beverly Hills, CA (US); Allan Wansky, Marietta, GA (US)

Correspondence Address: Wayne L. Tang;MAYER, BROWN, ROWE & MAW LLP, P.O. Box 2828, Chicago, IL, 60690-2828, US

(21) Appl. No.: 11/024,146

(22) Filed: Dec. 28, 2004

Related U.S. Application Data
(60) Provisional application No. 60/533,650, filed on Dec. 31, 2003.

(51) Int. Cl. G06F 17/60

(52) U.S. Cl. 705/36

(57) ABSTRACT

A trading system is disclosed which allows an exchange to protect market data from electronic reproduction by traders but allows the traders to use the market data (such as the last traded price, current resting bids and offers) to assist in making the trades. The system includes an exchange server having a database having market data relating to commodities traded over the exchange. A group of trader computers each having a display are coupled to the exchange server. The trader computers have a trader interface run on the computer allowing each trader to place and accept orders for commodities traded over the exchange. The trader interface is capable of receiving market data from the exchange server. An external data source such as an Excel spreadsheet is stored on the trader computer having at least one data field. A trader module is coupled to the trader interface and external data source. The trader module reads market data from the trader interface and the at least one data field of the external data source. The trader module displays the market data and the one data field on the display. The displayed data cannot be exported to the external data source but can be used to make trading decisions and manage orders.

### RELATED APPLICATIONS

This application claims priority from Provisional Application No. 60/533,650 filed Dec. 31, 2003. The contents of the application are hereby incorporated by reference.

### FIELD OF INVENTION

This invention relates to a system to protect exchange data but allow its use for electronic trading. More specifically, this invention relates to a system which integrates live exchange data with a user's other data sources for allowing a user to create custom formulas to facilitate trading on the exchange while protecting against copying and disseminating the electronic data from the exchange.

### BACKGROUND OF INVENTION

Traditional trading of commodities or financial instruments such as stocks and bonds has taken place in markets where traders offer to buy and sell various products at negotiated prices. Such trades were performed using hand signals and paper was used to finalize the actual trading contract. With the advent of computers, more complex and faster trades may be made by harnessing computer power.

Additionally, the growth of the Internet and other electronic communications systems has moved the realm of trading beyond the trading floor. With the increasing complexity of the economy, a greater diversity of financial commodity products may be offered including derivatives. Derivatives are defined as a financial contract whose value depends on the values of one or more underlying assets or indices of asset values. Presently, derivatives are traded in traditional exchanges which can include futures or options in commodities ranging from pork bellies to currency prices. Recently, derivatives have also been traded in the over-the-counter (OTC) market defined by transactions by large financial institutions such as commercial banks or insurance companies. Such derivatives can include swaps, options, caps, floors, corridors, etc. derived from interest rates, foreign currencies, equities and other commodities or financial instruments. One emerging over-the-counter market of derivative products is in the field of energy. With deregulation of the power industry, there is a much greater diversity of power generators with different types of energy sources such as natural gas, oil, electricity and solar. With such diverse energy sources and suppliers, a market has arisen in trading the commodities of energy between such producers. Various financial and physical derivative instruments such as swaps, options or spreads have been formulated by various players in the energy market. Players in this market range from traditional trading firms such as energy companies to banks, hedge funds and proprietary trading firms. Like many financial markets, technology eases accessibility to the over-the-counter energy derivative market.

Traders in the trading markets such as the OTC energy market have computers with trading software that allow them to make offers or bids for and execute trades of various commodity products. The offers or bids are submitted electronically to the server or servers which are managed by an exchange such as the Intercontinental Exchange (ICE) of Atlanta, Ga. in the field of OTC energy. The exchange sends data relating to the various commodity markets to computers used by traders who are participants on the exchange. The data includes the commodities which are being offered for sale and the commodities sought by other traders who are connected to the exchange. The trader computers have software which enables trades to be made based on commodities which are shown as available from other traders connected to the exchange.

Many exchanges now offer electronic trading. Some such as the Intercontinental Exchange were founded purely as an electronic exchange. In fact, most of an electronic exchange's business is conducted electronically using the public Internet as its primary network. An electronic exchange such as the ICE typically has two major logical components separated by a network such as the Internet. The first logical component is the back end or server side. The back end includes a set of servers, software processes and databases. The back end is responsible for receiving electronic orders, bids, and offers, processing trades, and electronically distributing the results. The second major component is the client side process on a client computer. Typically the client side process is a software client also known as a graphical user interface (GUI). The GUI is where a trader who is a participant on the exchange will view open bids and offers, enter new orders, and execute trades. Typically this GUI is provided by the exchange or is provided by a partner of the exchange termed an Integrated Service Vendor (ISV).

In addition to providing a client front end, exchanges typically offer an Application Programming Interface (API). An API is a software library that has all of the software necessary to digitally connect to and communicate with an electronic exchange. One reason APIs are offered to exchange participants is so that they have the option to build their own custom front end software to interface with the exchange. An exchange participant may choose to build its own custom front end software using the exchange's API for various reasons. The participant may already have its own proprietary front end or look and feel standards which they want the exchange GUI to conform to. There may be additional features that the participant would like to build into its custom solution that are not offered by the exchange's standard GUI. A participant may want to use the API to build a purely automated processing solution that takes the exchange's data and routes it to one of its internal risk management, accounting or other software or databases. Another custom application of an exchange's API is to use it to route the exchange's price data to a participant's proprietary pricing system. These pricing systems take inputs from various other data sources, and using custom formulas developed by the participant's traders, calculate bid and offer prices for the exchange's products. These generated bid and offer prices may then be sent back to the exchange for execution.

In general, an exchange API gives the exchange participant the power and flexibility to build tailored tools that allow them to trade more efficiently according to their trading style. Thus an API is a powerful tool and making an API available to exchange participants offers both benefits and risks to an exchange. An API allows participants to build custom tools and solutions that will allow them to be more productive participants on the exchange. However, the tailoring of a generic API by a participant requires significant development resources and is also a drain on the exchange's own support and development resources. It takes many hours of API support engineer time which is often offered as a complementary service to the participant. Further, the spread of the exchange's API opens the exchange to the risk of potentially poorly designed API engines which may threaten the viability of the exchange's trading system servers. More malicious users of the API may even use it to create digital attacks on the exchange. Finally, the availability of an API creates potential competitive threats to the exchange as it may be accessed by third party companies and developers whose business interests may conflict with the best interests of the exchange. These third parties may build applications that may undermine the exchange's market places by taking their price data and using it illegally or using it to support competing exchanges. It is important to note that the liquidity or continually changing price data is the life blood of any exchange. This price data is proprietary and is the essence of the exchange's value.

For example, a third party with access to an exchange's API could build a custom software product that would take the exchange's price feed data and route it to another database or software process that is not sanctioned by the exchange. More specifically, an unlicensed software tool using an exchange's API could be built that would take the exchange's price feed and co-mingle it with that of another exchange, one which perhaps lacked the same liquidity. The competing exchange would then appear to be as liquid or more liquid than the original exchange and over time could steal liquidity away from the original exchange, damaging its business.

Given these costs, risks and the competitive environment, it would greatly benefit an exchange to build and offer their own API engines which would be licensed to interested participants and at the same time would protect its liquidity by keeping its pricing data electronically secure. In doing so, the exchange could also reduce API support costs and the risk of poorly implemented front end APIs. However, these benefits run the tradeoff of allowing a trader access to the data from the exchange and thereby risking the loss of business from the initial exchange.

Thus, there is a need for a trader interface system supporting pricing calculations and inputs into an exchange that does not allow exchange data such as market prices from the exchange server to be input to any external data sources. There is a further need for a pricing engine which is based on tools that traders are already familiar with and that will give traders the power to make markets on a single exchange based on their own proprietary formulas and strategies. There is also a need for an application which may be easily integrated with spread sheet programs widely used by traders. There is also a need for a software interface which allows a trader to create formulas on external data sources and send calculated prices and other data to the exchange.

### SUMMARY OF THE INVENTION

These needs and others may be met by the present invention, one example of which is a market data protection system for electronically protecting the contents of a market database from digital reproduction by a user while allowing the user to use the market data. The system has a data interface having market data belonging to an exchange entity. An external data source is generated from an application program having user generated data. A trader module is coupled to the data interface, the trader module generates a data display allowing display of the market data belonging to the exchange entity, and data imported from the external data source. The market data displayed in the data display cannot be exported to an external software application.

Another example is a trading system which allows an exchange to protect market data from electronic reproduction by traders. The system has an exchange server having a database having market data relating to commodities traded over the exchange. A trader computer having a display coupled to the exchange server is provided. A trader interface run on the trader computer allows a trader to place and accept orders for commodities traded over the exchange. The trader interface is capable of receiving market data from the exchange server. An external data source is stored on the trader computer having at least one data field. A trader module is coupled to the trader interface and external data source. The trader module is capable of reading market data from the trader interface and the at data field of the external data source and display the market data and the one data field on the display. The displayed data cannot be read by the external data source.

Another example of the present invention is a method of providing a trader access to market data from a trading exchange server for calculations based on the market data while preventing the trader from electronically copying the market data. The method includes sending market data from the exchange server. The market data is received on a trader interface. An external data source is provided. The method allows market data to be displayed on the trader interface and data to be copied from the external data source. Data from the trader interface is prevented from being copied by the external data source.

It is to be understood that both the foregoing general description and the following detailed description are not limiting but are intended to provide further explanation of the invention claimed. The accompanying drawings, which are incorporated in and constitute part of this specification, are included to illustrate and provide a further understanding of the method and system of the invention. Together with the description, the drawings serve to explain the principles of the invention.

### BRIEF DESCRIPTION OF DRAWINGS

These and further aspects and advantages of the invention will be discussed more in detail hereinafter with reference to the disclosure of preferred embodiments, and in particular with reference to the appended Figures wherein:

FIG. 1 is a block diagram of a computer based trading system which allows protection of exchange data from traders;

FIG. 2 is a screen print of the interface for a trader to communicate to the exchange and other traders;

FIG. 3 is a block diagram of the software components of the market data protection system in the trader computer in FIG. 1;

FIG. 4 is a block diagram of the software components of the formula trader module in FIG. 3;

FIG. 5 is screen print of the user interface of the formula trader interface shown in FIG. 3;

FIG. 6 is a screen print of the user interface in FIG. 5 showing links to exchange data and formula calculation;

FIG. 7 is a screen print of the order entry screen which allows use of the formula trader module in FIG. 3.

FIG. 8 is a screen print of a configure channel window; and

FIGS. 9A & 9B are screen prints of the user interface in FIG. 5 showing use of data from the exchange, an external data source and the formula calculation function.

### DESCRIPTION OF THE PREFERRED EMBODIMENT

While the present invention is capable of embodiment in various forms, there is shown in the drawings and will hereinafter be described a presently preferred embodiment with the understanding that the present disclosure is to be considered as an exemplification of the invention, and is not intended to limit the invention to the specific embodiment illustrated.

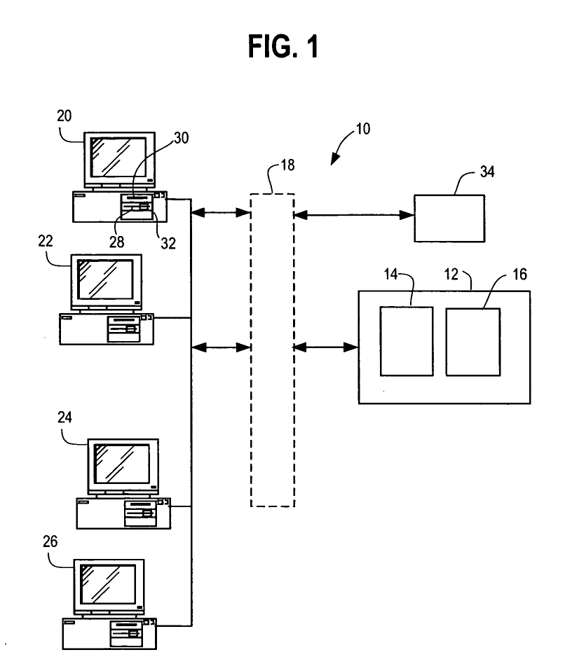

FIG. 1 shows a block diagram of an electronic trading system 10 which is an example of a platform which uses the market data protection system of the present invention. The electronic trading system 10 has an exchange server 12 which is provided by a trading exchange such as the Intercontinental Exchange which offers trading in energy related derivative products. The exchange server 12 runs a matching engine software program 14 which provides trading functions for receiving orders, price changes, order cancellations, executing trades and sending data relating to available commodities such as the market type, the quantity and price of bids and offers, and notification of trades executed in the commodities traded over the exchange. The trades are recorded by the matching engine software 14 and stored in a database 16. The exchange server 12 is coupled via a network such as the Internet 18 with trading computers such as computers 20, 22, 24 and 26. As will be explained, each of the computers 20, 22, 24 and 26 have a display and interface software 28 for the submission of offers and bids in markets offered by the exchange server 12. The interface software 28 also receives and displays market data relating to various markets of interest to a trader or broker from the exchange server 12. The interface software 28 thus serves as a data interface having market data belonging to the exchange entity which runs the exchange server 12. The market data is stored in a market database (not shown) which is part of the exchange server 12. Of course, it is to be understood that computers 20-26 are merely shown as examples and there can be numerous computers which submit trade data to the exchange server 12. It is also to be understood there may be multiple servers and other computers which overall perform the functions of the matching engine software 14, but for simplicity only one server is represented in this example.

In this example, traders and brokers interface with the exchange server 12 interfaces via computers such as the computer 20 with an Internet browser program 30 having the capability of running Java, HTML and JavaScript. The user is thus presented with a web interface displayed on the user computer 20 to perform the various trading functions according to the interface software 28 or API which is preferably implemented as a Java applet used in conjunction with the web browser program. Of course, it is to be understood that any of the other trading computers 22, 24 and 26 may also be capable of running the user interface via a web browser program.

The trading system 10 allows a trader to utilize other software utilities and applications to assist in managing orders from the exchange server 12. One example of such a software utility or application program is a spreadsheet program 32 run on the computer 20 which may have user or trader generated data. As will be explained below, the market data protection system allows a trader to use formulas set up through the spread sheet program 32 or other external sources of data to assist in making trades. For example external data may be obtained from a separate data source 34 which is coupled to the computer 20 via the Internet 18. The separate data source 34 may be any direct data exchange publisher of market prices such as CQG. Such programs can use data from the exchange server 12 but the market data protection system prevents the access to the data from the exchange server 12 via digital format to the computer 20. The trader may use data from a spreadsheet or other external software utilities in conjunction with data supplied by the exchange server 12 without placing data from the exchange server 12 in the spreadsheet program 32 or any other external software utility. Further, the market data protection system allows a trader to emulate the formulas created from the spreadsheet program 32 via use of data by the exchange server 12.

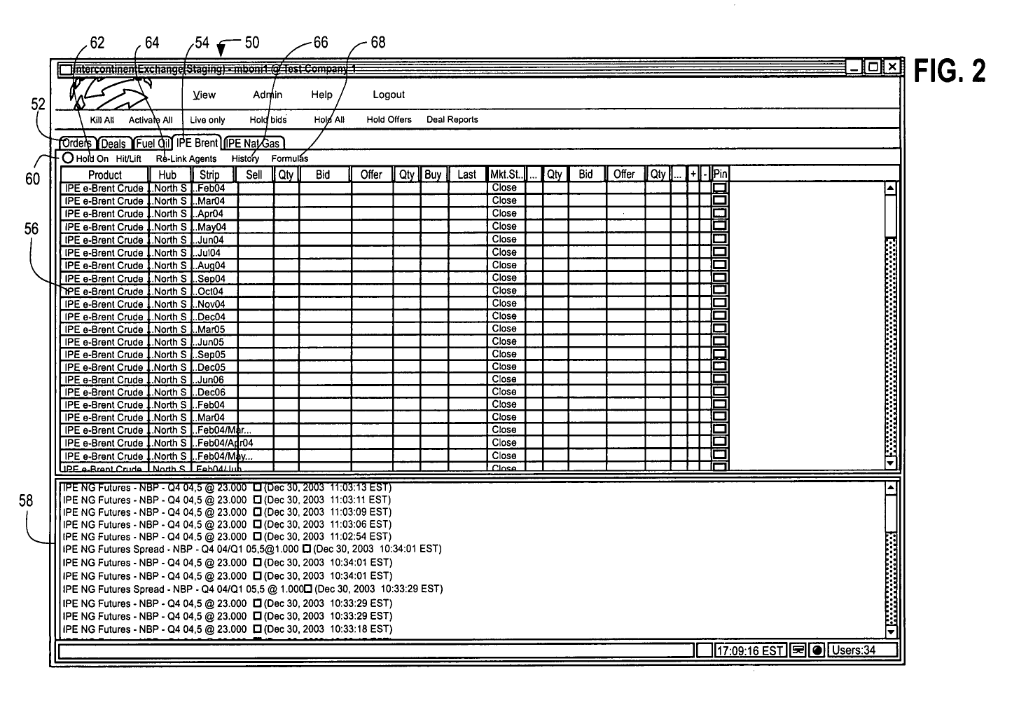

FIG. 2 is a screen print of a user interface 50 which is generated by the interface program 28 on the computer 20 to allow electronic trading by communication with the exchange server 12. The user interface 50 has a number of portfolio tabs 52 each of which when selected displays a window with information relating to markets which are bundled in the portfolio. In the example in FIG. 2, a tab 54 representing a specific market portfolio relating to a specific commodity has been selected. A markets window 56 displays different markets in rows and has columns which include price, quantity and other data obtained through the exchange server 12. A trade ticker window 58 is displayed below the market window 56 to show a continuous stream of quotes for different markets.

The user interface 50 allows a trader to perform various functions relating to markets traded in the exchange. The interface 50 allows a trader to view markets, bid and offer in markets for commodities, and manage orders. The interface 50 also allows a trader to create and modify portfolios of markets and produce different reports.

The markets window 56 includes a menu bar 60 which includes a hold on hit/lift selection 62, a re-link agents selection 64, a history selection 66 and a formulas selection 68. The hold on hit or lift selection 62 allows a trader to remove all the orders from a portfolio when one of the orders in the portfolio is executed. The re-link agents selection 64 allows a trader to reestablish communications links to the data sources available to the user. The history selection 66 allows a trader to display transactions and other actions performed. The formulas selection 68 allows a trader to access the formulas model to apply formulas generated on their own computer 20 to data from the exchange server 12 displayed by the user interface 50.

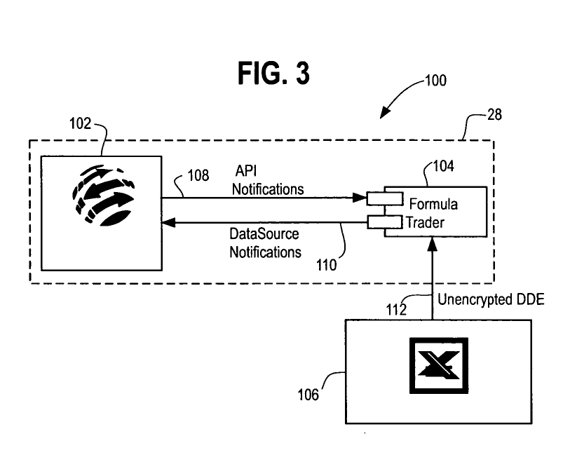

FIG. 3 is a high level block diagram of an exchange market data protection system module 100 which is enabled when the formula selections 68 is selected by the trader on the interface 50. The software components are installed on the trader computer 20 as part of the GUI Java applet although other programming methods may be used. The exchange data protection system 100 has a web interface module 102, a formula trader module 104 and an external data source such as an Excel spreadsheet document 106. External data may also be added to the cells of the spreadsheet document 106 and combined with data from the exchange server 12 to assist in pricing decisions. The different modules of the exchange data protection system 100 typically run within one computer. The web interface module 102 and the formula trader module 104 are different software components of the interface program 28. The web interface module 102 provides a user interface to the exchange server 12 via the web browser software 30 on the trader computer 20 in FIG. 1. The formula trader module 104 is a Java extension to the web interface program 28. The formula trader module 104 merges the data from the exchange server 12 and data received from the spreadsheet document 106.

Market data can flow freely between the exchange server 12 and the web interface module 102. Market data may also flow freely between the web interface module 102 and the formula trader module 104. Market data may only flow from the user's external data source such as the Excel spreadsheet 106 into the formula trader module 104. The market data from the exchange server 12 and the data imported from the external data source 106 are combined in the formula trader module 104 and displayed for use to make trading decisions or manage orders on the exchange server 12.

This arrangement prevents the trader from receiving programmatic access to the exchange market data in the course of using the exchange market data in trading formulas via the spreadsheet document 106. Thus, the exchange market data displayed cannot be exported to an external software application. As will be explained below, the formula trader module 104 provides an approximation of all functions such as formula creation and calculation in the spreadsheet document 106.

Data from the exchange server 12 is sent to the interface program 28 through the web interface module 102 to the formula trader module 104 via an API notification layer 108. Data generated from the formula trader module 104 is sent to the web interface module 102 and hence to the exchange server 12 via a data source abstraction routine 110.

Protection of the data from the exchange server 12 is maintained by the lack of any ability for the spreadsheet document 106 to electronically obtain data from the formula trader module 104 which is proprietary code to the exchange and inaccessible to the trader. However, data may be extracted from the spreadsheet document 106 to the formula trader module 104 via an unencrypted dynamic data exchange (DDE) link 112. The DDE link 112 is programmed for generic data or for data formatted from specific external data sources including spreadsheet programs such as Excel or other trading software tools that use dynamic data exchange.

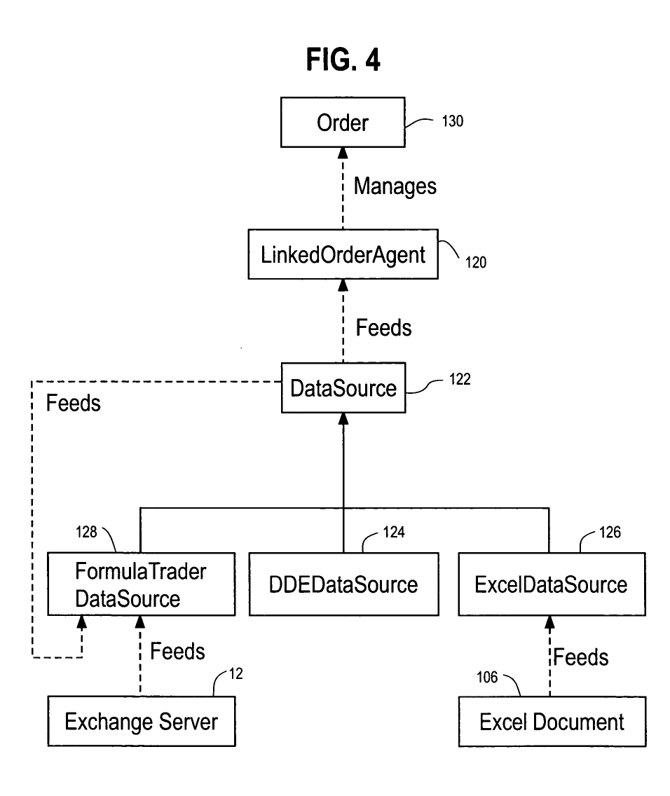

FIG. 4 is a block diagram of the programming objects of the data source abstraction routine 110 in FIG. 3 that are used to send data to the web interface 102 from the formula trader module 104. In a basic prior art trading system, the user is responsible for directly manipulating all of the orders. The user must decide which orders to place into the market and which ones to keep inactive or held. The user also must remove existing orders and float new ones, or adjust the characteristics of existing orders, as market conditions change.

The web interface module 102 provides a LinkedOrderAgent 120 which is a piece of code that has the authority to make some of these decisions on an automated basis, taking actions (by altering existing orders) when certain conditions are met. The LinkedOrderAgent 120 allows a trader to automatically manage an order in the market based on external information fed into the system by one of previous described data sources. For example, the user will attach a LinkedOrderAgent to a cell on an Excel spreadsheet that contains the user's best price for a given product. As the user changes the value in the cell, the LinkedOrderAgent will update the price of the order in the market. The LinkedOrderAgent object 120 thus requires input of data from an external data source such as the spread sheet 106 in FIG. 3 or some other external data feed.

A DataSource object 122 is a named path for data to be delivered to the LinkedOrderAgent object 120. A number of possible data sources 124, 126 and 128 are shown. One possible data source uses DDE to monitor other software applications such as a DDE enabled application 124 and in particular a spreadsheet program 126 which in this case is the Excel spreadsheet 106. Another data source is a FormulaTrader DataSource object 128, where a user can combine data from multiple sources using spreadsheet type formulas as will be explained below. Specifically, the FormulaTrader DataSource object 128 presents a software location where current market data from the Exchange Server 12 can be combined with data from other data sources such as the Excel spreadsheet 106 by writing spreadsheet style formulas.

The external data source objects 124, 126 and 128 represent the connection to the external data sources and manages channels which are connected to specific data fields in the external data sources. In this example, the channels represent connection to specific data cells in the spread sheet 106. Other data fields such as price feeds and formula engine results fields may have channels. The concrete data sources are configured via properties objects using a predefined Java class allowing flexibility in assigning characteristics to the different data sources.

The data source object 122 includes a channel listener object which is associated with a particular channel which is in turn linked to a specific data field in the external data sources. The channel listener object receives asynchronous notifications from the data source object 122 when information on that channel has changed. The data source object 122 also includes a channel event object which encapsulates information about a particular notification on the data source interface object 122. In particular, the channel event object indicates the channel that is the reason for the notification to the data source interface 122.

A data source interface routine is used to send updated data from external data sources such as the spread sheet 106, files from other DDE enabled programs, or even the formula trader module 104 itself. Each external data source has its own set of objects and channels dedicated to data from that source. The data source interface routine is initiated on the addition of external data sources or the change of data which is monitored by the formula trader module 104. As will be explained below, the formula trader 104 allows a user to establish a link to external data for purposes of operations such as creating formulas.

Other agents such as the LinkedOrderAgent 120 may be installed in the web interface 102 in FIG. 3. For example, a Hold On Hit Or Lift Trader Agent may be installed to hold all of a trader's orders in a market once one of his orders is transacted. Another example is a Custom Spread Agent which is used to automatically generate a spread transaction (for example buy one commodity and sell another), in places where such transactions are not pre-defined by the exchange. Trade agents based on other trading strategies could be implemented. For example, a Follow Agent manages an order's price by following the best price in a market by a specified amount. An Option Agent updates the premium for calls and puts for options orders as the underlying commodity price changes. A Re-float Reserve Agent re-floats orders at a higher or lower price if its managed order is hit or lifted.

A number of trading strategies makes use of an Agent that places new offsetting orders in the market when trading thresholds are reached, such as a Hedge Agent to limit total volume traded, a Stop Loss Agent or a Stop Loss Limit Agent to protect against price movements. A Discretionary Order Agent is another offsetting order agent that is not shown to the market, but stays hidden until some pre-defined set of market pricing criteria are met. This is not a contingent order. It basically examines market information, bids, offers, trades, price range, etc. and then either floats a bid or offer and works it, or executes an automatic trade. The second part of the function (bid, offer, trade) usually has a time parameter assigned to it. There are numerous other strategies that can be realized as Trader Agent implementations.

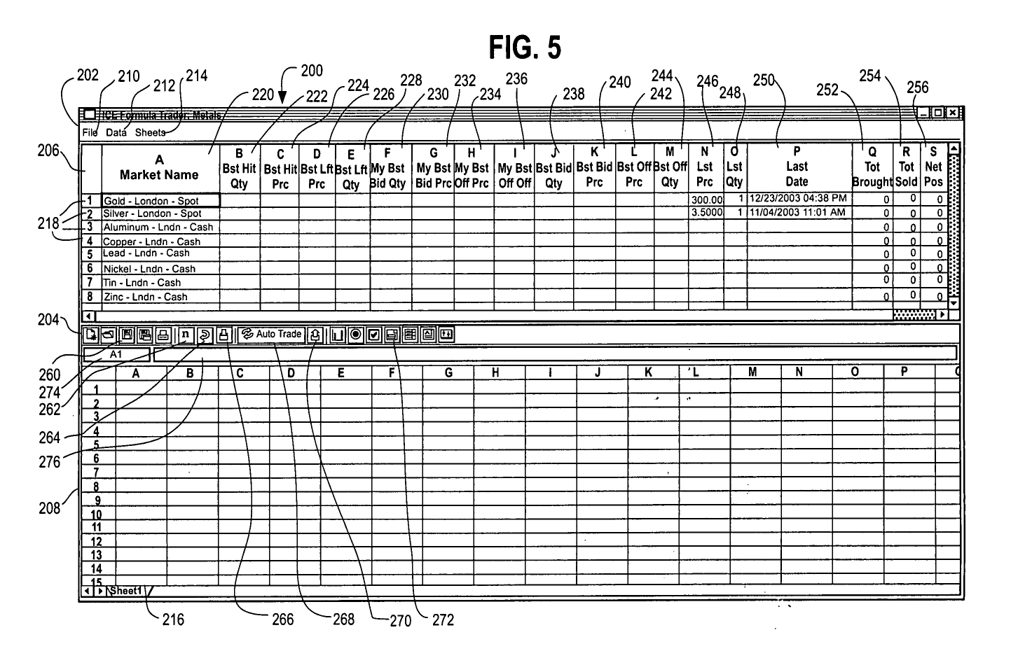

FIG. 5 is a screen shot of a user interface 200 which is generated by the formula trader module 104 in FIG. 3. The user interface 200 is unique to each trading portfolio maintained by the trader and managed by the interface 50 shown in FIG. 2. The user interface 200 has a menu bar 202, a tool bar 204, a market data window 206 and a user data window 208.

The menu bar 202 has a file menu 210, a data menu 212 and a sheets menu 214. The file menu 210 is a pull down menu which allows a user to manage various user data windows or workbooks such as the user data window 208 through opening a new workbook, opening an existing workbook, saving a workbook and printing a workbook. The data menu 212 allows a user to name cells in the user data window 208 and link those cells to data fields in various data sources as will be explained below. The sheets menu 214 allows a user to insert a new sheet, delete the currently selected sheet or change the properties of the current sheet. Each user data window 208 may have any number of sheet tabs 216 which when selected displays a different sheet of data cells.

The market data window 206 contains data for all markets for which the trader may apply the formulas in the spreadsheet document 106 in FIG. 3 or formulas in the user data window 208. If approved by the exchange, the trader is given access to any requested market which is made available through the exchange server 12. The data in the market data window 206 is updated by the web interface module 102 which receives data from the exchange server 12 to the trader formula module 104 in FIG. 3. The market data window 206 is built as a read-only spreadsheet. Cells in the market data window 206 may be referenced by the user data area 208 which may then use the referenced cells in formulas. As explained below, this data is viewable by the user in the market data window 206 and the user data window 208, but cannot be electronically accessed by external programs such as the spread sheet document 106 in FIG. 3, thus protecting the market data from the exchange server 12.

The market data window 206 has different rows 218, each of which represent a market in the trader's portfolio. The data in the cells of the different rows are imported from a database of the exchange server 12 and are updated as they change according to the markets. The columns for each row include a market name column 220, a best hittable bid quantity column 222, a best hittable bid price column 224, a best liftable offer price column 226, a best liftable offer quantity column 228, a best active bid quantity column 230, a best active bid price column 232, a best active offer price column 234, a best active offer quantity column 236, a best bid quantity in the market column 238, a best bid price in the market column 240, a best offer price in the market column 242, a best offer quantity in the market column 244, a last price in the market column 246, a last quantity in the market column 248, a last date column 250, a total amount column 252, a total amount sold column 254 and a net position in market column 256.

Different markets may be displayed or eliminated from the display using a popup window menu (not shown). The popup menu will display a list of markets available to the trader and allow the trader to add a row to the market data window 206 representing the added market.

The user data window 208 is the screen area used by the trader may create and build formulas such as spreadsheet formulas which may incorporate data from the exchange as well as from external sources. The user data window 208 thus serves as an interface to trade within the exchange server 12 and link data from external data sources such as a spreadsheet or a trader utility software program. The user data window 208 is a spreadsheet document and allows a user to enter different types of information such as text or numbers in the data cells. As a spreadsheet, the user data window 208 allows a user to enter formulas based on market data received from the exchange server 12 and external data feeds such as an Excel spreadsheet. Spreadsheet functionality is provided including the capabilities to write formulas, add or remove sheets and save or load a workbook. Information in the cells may include text information, a link to one of the cells in the market data window 206, a link to a spreadsheet created by the trader, and a formula created by the spreadsheet program.

Once the cells in the columns of the user data window 208 are populated, the trader can float an order linked to a cell or groups of cells linked to a market row in the market data window 206. The cells in both the user data window 208 and the market data window 206 are simultaneously updated with the receipt of new data which effects any of the formulas.

The tool bar 204 includes various buttons which replicate commands available in the file menu 210 of the menu bar 202. The tool bar includes a series of file buttons 260, a name cell button 262, an add market data link button 264, a select external data feed 266, an auto trade button 268, a send data to exchange button 270 and graphics buttons 272.

The workbook in the user data window 208 has spreadsheet functionality. A user may define formulas using the data cells in the user data window 208 by a cell indicator 274 and a formula area 276. The graphics buttons 272 allows the ability to imbed charts and graphic objects in the workbook represented by the user data window 208.

The name cell button 262 allows the user to name a selected cell in the user data window 208 for purposes of linking an order. Once a cell is selected in the market data window 206 and a cell is selected in the user data window 208, the add market data link button 264 may be selected to link the two cells. The add market data link button 264 will write a cross-sheet formula into the user data window 208, referencing the cell in the market data window 206.

A trader may add an external data source such as a spreadsheet or any other document which supports DDE data transfer to the worksheet using the select external links button 266. The select external links button 266 will invoke an administer external data links dialog screen (not shown) which allows the user to select a cell reference to a cell in the external spreadsheet. The user may elect to configure the formula trader in an auto-trade mode by selecting the auto trade button 268. The auto trade button 268 will configure the system to automatically send changes reflected by changes in data and associated formulas to the exchange server 12 based on data in the market data window 206 in the linked cell in the user data window 208. If the auto trade button 268 is not selected, the system is in manual mode and updates of the linked orders in the user data window 208 will only be sent to exchange server 12 when a trader selects the send data to exchange button 270 on the tool bar 204. This allows a trader to evaluate changes made to the worksheet in the user data window 208 before updating the orders.

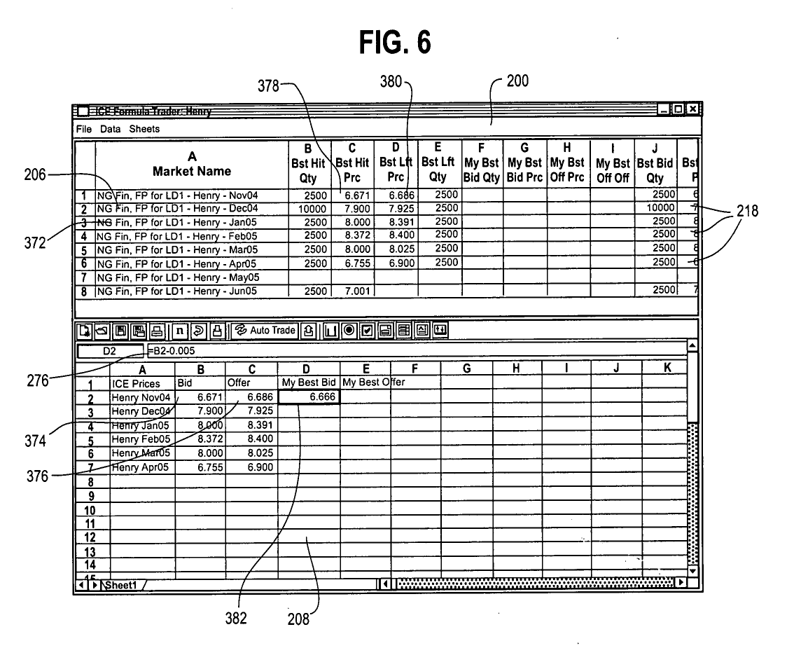

FIG. 6 shows the use of the user interface 200 to make a simple formula using data from the exchange server 12 in the market data window 206. In this instance the user has opened the user data window 208 and has selected various markets of interest 372 in the rows 218 of the market data window 206. The data for the markets of interest 372 is thus displayed in the rows 218.

The user can use the user data window 208 by linking a field of the market data window 206 to a cell in the user data window 208. In this example, the user has selected the value in the first row of the best hit price column 222 and linked the value via the market data link button 264 to a bid cell 374 and an offer cell 376 in the user data window 208. In the example shown in FIG. 6, the data in cells 378 and 380 in the best hit price hit column 222 and best lift price column 224 have been linked to respective cells 374 and 376 in the user data window 208. As can be shown, the value in cell 374 of the user data window 208 are the same as the value in the cell 378 of the market data window 206. The remainder of the cells in the user data window 208 may be used to set up formulas using the linked data from the market data window. For example, a formula may be written in the formula area 276 which references the cells 374 and 376 resulting in a cell 382. In this example the formula subtracts 0.005 from the price value in the bid cell 374. Of course more complex formulas may be set up by the user. For example, the user may creates a formula that compares the market price to the predicted price, and computes a price that the trader is willing to buy and sell at. Such a formula is written in standard Excel spreadsheet notation in the formula area 274, combining the values of different cells in the user data window 208 using simple math expressions.

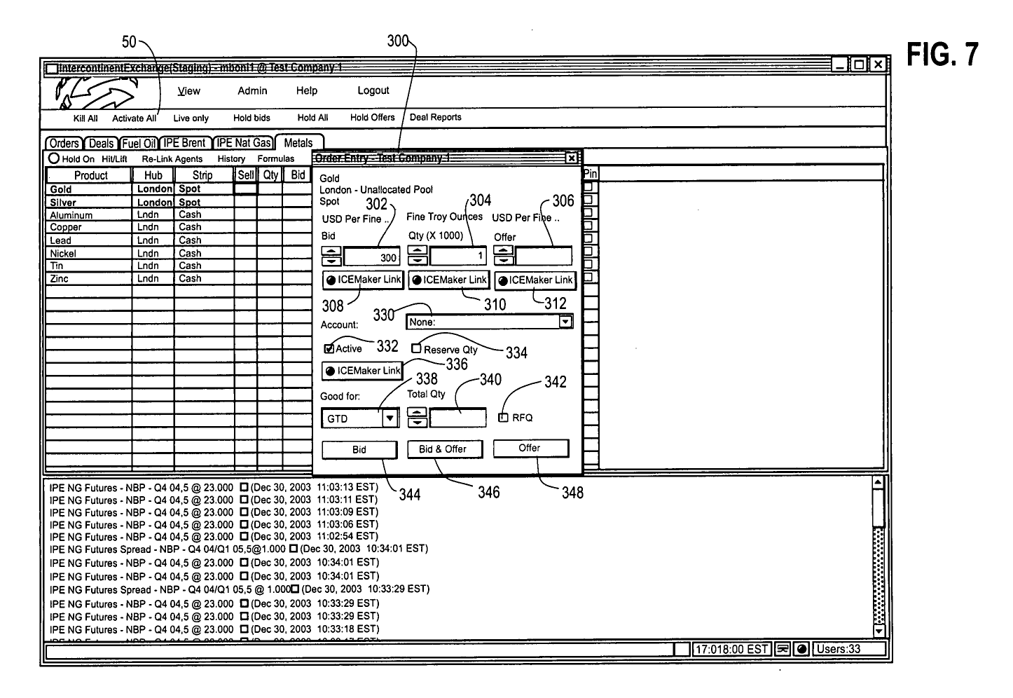

FIG. 7 shows an order entry screen 300 which is displayed when a trader places an order using the user interface screen 50 shown in FIG. 2. The order entry screen 300 has information relating to the selected market such as the name of the market and a brief description. The order entry screen 300 has a bid price field 302, a quantity field 304 and an offer price field 306. The fields 302, 304 and 306 include arrow controls to increase or decrease the amounts shown in the fields. Each of the fields 302, 304 and 306 has a link button 308, 310 and 312 respectively. The link buttons 308, 310 and 312 may be selected to link and select the external data source which contains the information of interest.

The selection of the link buttons 308, 310 or 312 will cause the web interface 102 to create a trader agent such as the LinkedOrderAgent 120 in FIG. 4 which will manage a newly created order 130 shown in FIG. 4. As the data sources 124, 126 and 128 and in particular the FormulaTrader DataSource object 128 feed updated data to the LinkedOrderAgent 120, the LinkedOrderAgent 120 will alter the order 130 according to the new data.

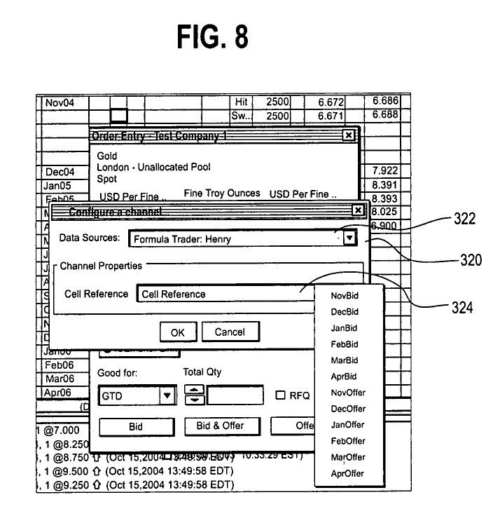

FIG. 8 shows a configure channel window 320 which is displayed when the link buttons 308, 310 or 312 is selected. The configure channel window 320 has a data sources field 322 which allows a user to select an external data source from a list of data sources such as the spreadsheet 106 in FIG. 3. The list of external data sources is established by the trader by designating certain data sources from data sources which are compatible with the user interface 50. The configure channel window 322 also has a cell reference field 324. The cell reference field 324 allows the trader to specify the specific data field in the external data source associated with the channel. The specific data field may be specified using a row and column designation or by using a cell name defined by the spreadsheet document. Upon selection of the external data source and the channel in the fields 322 and 324, the objects of a agent trader routine as explained in FIG. 4 are created.

Returning to FIG. 7, the order entry screen 300 has an account field 330 which allows the selection of a clearing account which is designated by the system administrator of a bilateral clearing mechanism if there is no designated clearing account. The order entry screen 300 also includes an active selection box 332 and a reserve quantity box 334. Checking the active selection box 332 will make the order an active order placed to the exchange. Checking the reserve quantity box 334 will hold back the full quantity desired by the trader and only show the order quantity in small increments, re-sending the order into the market upon each incremental execution until the full quantity is met. An additional link button 336 is provided for additional data sources to define a trade as active or reserve. The link button 336 is identical to the other link buttons 308, 310 and 312 and allows the user to define a data source using the configure channel window 320 in FIG. 8. The order may be given a time of duration by selecting one of the time ranges in the good for field 338. Additional orders for the market may be placed automatically up to a certain limit defined by a total quantity field 340 with associated arrow controls. An RFQ selection box 342 allows a trader to make a request to quote for a designated commodity to other traders on the exchange.

The order entry screen 300 has a bid button 344, a bid and offer button 346 and an offer button 348. The buttons may be color coded according a scheme which may be used on the user interface 50 in FIG. 2 depending on whether a function is a bid or an offer. After a trader completes filling out the order using the total quantity field 304 in conjunction with either the bid price field 302 or the offer price field 306, selecting the appropriate bid button 344 or offer button 348 will post the order to the exchange 12. The bid and offer button 346 may be used to place both a bid and offer simultaneously to the exchange 12. Since the order is linked to external data, orders may be made automatically based on information in external data sources.

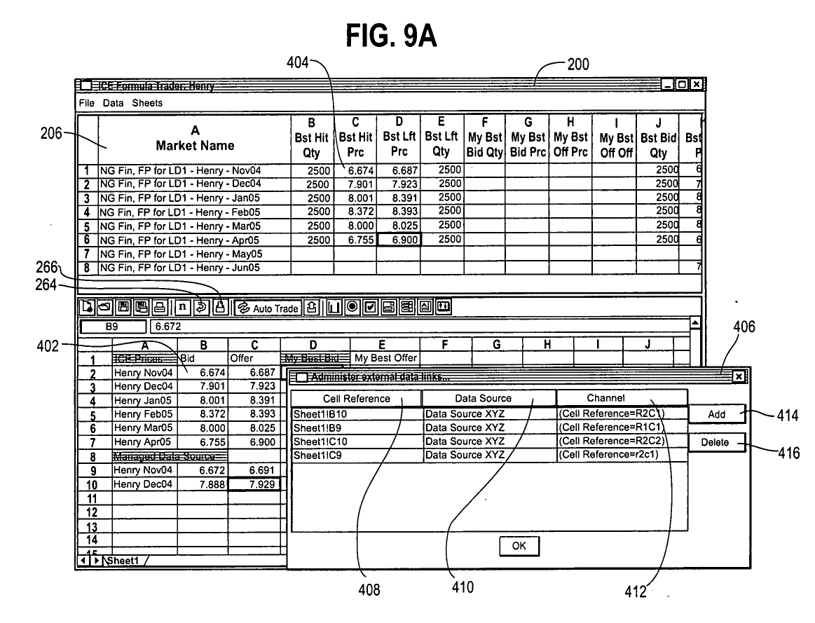

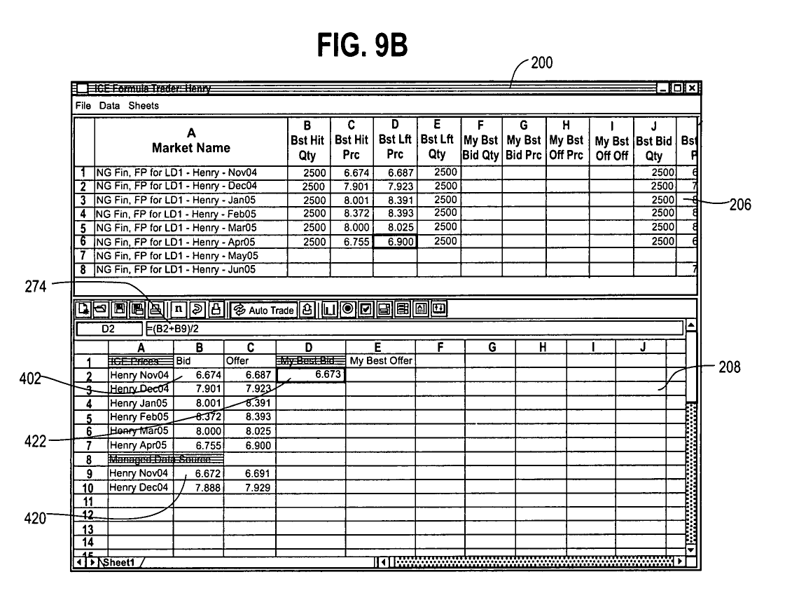

Thus, other more complex operations involving automatically making orders may be facilitated by the user interface 200. A trader's company may analyze commodity production and demand, and provide the trader with predictions in the form of an external data source such as an Excel spreadsheet. The sheet may contain specific price predictions in specific markets. Such an operation may be seen in FIG. 9A, which shows the user interface 200 in FIG. 5 after the user has selected the markets of interest in the market data area 206, so the current market activity data is available for writing formulas. As in the example in FIG. 6, the user has linked various data fields such as a bid cell 402 in the user data window 208 to a data field 404 in the best hit price column 222 using the add market data link button 264. In the user data window 208, the user uses an Excel spreadsheet (not shown) as an external data source to import the price predictions from his company's spreadsheet via the external data feed button 266. Selecting the external data feed button 266 opens an administer data link window 406 which has a cell reference column 408 and a data source reference 410 and a channel column 412. The cell reference column 408 defines the cell 402 in the user data window 208, while the data source reference column 410 defines the file of the external data source such as the Excel spreadsheet. The channel column 412 defines the cell in the external data source which contains the data desired to be used in the user data window 208. Additional data sources may be added with an add button 414 and data sources displayed may be deleted via a delete button 416. In this example, the cells of the external data source are predictive prices which could be determined by the user using proprietary predictive formulas.

FIG. 9B shows the resulting user data window 208 which contains cells such as the cell 402 which is information from the exchange server 12 linked through the market data window 206 and cells such as cell 420 which shows data from the external data source. In this instance a formula cell 422 which contains the best bid price for the user using the linked data. The best bid price is defined by the formula in the formula area 274 to be an average price between the cell 402 which represents the market hit price and the cell 420 which represents a predicted price from the external data source. Of course other more complex calculations and operations may be used utilizing both user data and market data in the user data window 208.

The user may floats an Order using the LinkedOrderAgent using the interface explained in FIG. 4. This Agent controls the Order, adjusting the price on the order to match the value computed in the FormulaTrader. As market conditions change, or as the values are updated in the prediction spreadsheet, the Agent will continue to manage the Order's price, with no other actions required by the trader.

It will be apparent to those skilled in the art that various modifications and variations can be made in the method and system of the present invention without departing from the spirit or scope of the invention. Thus, the present invention is not limited by the foregoing descriptions but is intended to cover all modifications and variations that come within the scope of the spirit of the invention and the claims that follow.

1. A market data protection system for electronically protecting the contents of a market database from digital reproduction by a user while allowing the user to use the market data, the system comprising:
a data interface having market data belonging to an exchange entity;
an external data source generated from an application program having user generated data;
a trader module coupled to the data interface, the trader module generating a data display allowing display of the market data belonging to the exchange entity, and data imported from the external data source; and
wherein the market data displayed cannot be exported to an external software application.

2. The system of claim 1 wherein the trader module allows the user to place orders for buying and selling to the exchange entity.

3. The system of claim 1 wherein the external data source is a spreadsheet and the application program is a spreadsheet program.

4. The system of claim 3 wherein the spreadsheet is a Microsoft Excel spreadsheet.

5. The system of claim 1 wherein the trader data routine updates the display by displaying a second set of market data from the exchange entity.

6. The system of claim 1 wherein the user interface is a Java applet installed on a web browser program and the trader module is a Java extension.

7. The system of claim 1 wherein the data display includes a market data window having data cells showing the data from the exchange entity and a user data window having data cells, the data cells in the user data window being linked to at least one data cell in the market data window.

8. The system of claim 7 wherein the user data window has at least one data cell being linked to the external data source.

9. The system of claim 7 wherein the user data window includes tools allowing a user to write mathematical formulas to produce data as a function of the data cells in the user data window, the data produced by the formulas usable to assist the user in making decisions to buy and sell.

10. The system of claim 1 wherein the formula trader module includes a trading agent software module which makes orders to the exchange entity based on market data and external data.

11. A trading system which allows an exchange to protect market data from electronic reproduction by traders, the system comprising:
an exchange server having a database having market data relating to commodities traded over the exchange;
a trader computer having a display coupled to the exchange server;
a trader interface run on the trader computer allowing a trader to place and accept orders for commodities traded over the exchange, the trader interface capable of receiving market data from the exchange server;
an external data source stored on the trader computer having at least one data field;
a trader module coupled to the trader interface and external data source, the trader module being capable of reading market data from the trader interface and the at least one data field of the external data source and display the market data and the one data field on the display, wherein the displayed data cannot be read by the external data source.

12. The system of claim 11 wherein the external data source is a spreadsheet generated by a spreadsheet program.

13. The system of claim 12 wherein the spreadsheet is an Excel spreadsheet.

14. The system of claim 11 wherein the exchange server is capable of sending a second set of data to replace the market data, the trader module receiving the second set of data and displaying the second set of market data.

15. The system of claim 11 further comprising a web browser program run on the trader computer, and wherein the user interface is a Java applet installed on the web browser program and the trader module is a Java extension.

16. The system of claim 11 wherein the trader module displays the market data and external data in a market data window having data cells showing the market data a user data window having data cells, the data cells in the user data window being linked to at least one data cell in the market data window.

17. The system of claim 16 wherein at least of the data cells in the user data window is linked to the data field of the external data source.

18. The system of claim 16 wherein the user data window includes tools allowing a user to write mathematical formulas to produce a resultant data cell as a function of the data cells in the user data window, the data produced by the formulas usable to assist the user in making decisions to buy and sell.

19. The system of claim 18, wherein the user data window allows a trader to make a trade based on the resultant data cell.

20. The system of claim 11 wherein the formula trader module includes a trading agent software module which makes orders to the exchange entity based on market data and external data.

21. A method of providing a trader access to market data from a trading exchange server for calculations based on the market data while preventing the trader from electronically copying the market data, comprising:
sending market data from the exchange server;
receiving the market data on a trader interface;
providing an external data source;
allowing the market data to be displayed on the trader interface and data to be copied from the external data source; and
preventing data from the trader interface to be copied by the external data source.
